(19) United States
(12) Patent Application Publication
(10) Pub. No.: US 2009/0003219 A1
(43) Pub. Date: Jan. 1, 2009

(54) Monitoring Performance Metrics Associated With a Wireless Network

(75) Inventors: Gordon B. Beacham, San Diego, CA (US); Phillip Kent Freyman, Elgin, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/771,437

(22) Filed: Jun. 29, 2007

(51) Int. Cl. G06F 11/00; H04Q 7/24

(52) U.S. Cl. 370/241; 370/338

(57) ABSTRACT

An access point device operating within a wireless local area network (WLAN) includes a network interface operable to facilitate communication with a network operator over an IP network. The network operator is located outside of a range of the WLAN. The access point device also includes a wireless network interface operable to facilitate communication between the access point device and a user device. The access point device further includes a processor operable to gather a first performance metric associated with the access point device and receive a second performance metric gathered by the user device in response to an instruction from the access point device to gather the second performance metric. The processor may facilitate transmission of the first and second performance metrics over the IP network to the network operator.

### FIELD OF INVENTION

Disclosed herein are various embodiments relating to wireless networks. More particularly, the various embodiments are directed to monitoring performance metrics associated with a wireless network.

### BACKGROUND

Wireless devices are increasingly becoming the standard means of communication for many homes and businesses. Popular wireless devices include communications devices, such as cellular telephones, cordless telephones, and Voice over Internet Protocol (VoIP) systems, which often utilize wireless handsets to communicate over an IP network, such as the Internet. Wireless devices also include computing devices, such as laptops and other personal computing devices. Wireless devices typically operate on a wireless network, such as a wireless local area network (WLAN).

In many instances, users experience a variety of quality of service (QoS) problems due to RF signal quality or loss of connection, which hinders or prohibits the transmission of data in a WLAN. These problems can often be attributed to continually changing RF environments. For instance, a wireless garage door opener operating within range of a WLAN may affect the performance of the WLAN. As a result, the WLAN may sporadically exhibit better or worse performance at different times within the same location. In addition, geographical features and man-made structures may also impact a user's wireless connection. Therefore, a wireless device may have different connection strengths at different locations within a WLAN.

Conventional solutions aimed at correcting QoS problems in a WLAN all rely on the physical presence of a trained individual. For example, a field technician, equipped with expensive diagnostic tools, such as computer equipment with complex software, is dispatched by an Internet Service Provider (ISP) to a subscriber's premises to evaluate the subscriber's wireless network. Otherwise, the subscribers themselves are taught how to analyze a wireless network and how to communicate the results back to the ISP. Once the WLAN has been analyzed, then corrective action can be taken to improve the performance of the WLAN. However, the manual solutions currently available for analyzing WLANs are costly, inefficient, and time-consuming. Thus, current solutions for evaluating QoS of wireless networks are logistically and economically untenable in light of the ever-growing number of wireless subscribers.

### SUMMARY OF INVENTION

An access point device operating within a WLAN may include a network interface operable to facilitate communication with a network operator over an IP network. The network operator is remotely located and is typically outside of a range of the WLAN. The access point device may also include a wireless network interface operable to facilitate communication between the access point device and a user device operating within the WLAN. For example, the access point device may comprise a modem and the user device may comprise a wireless handset. A processor within the access point device gathers a first performance metric associated with the access point device and instructs the user device to gather a second performance metric associated with the user device.

The access point device may receive the second performance metric gathered by the user device in response to the instructions from the access point device to gather the second performance metric and may further transmit the first and second performance metrics over the IP network to the network operator.

A method for remotely monitoring performance of a WLAN comprises invoking a performance module on a first device operating within the WLAN. For example, the first device may be an access point device. The method further includes gathering a first performance metric associated with the WLAN locally by the first device and transmitting a message to a second device operating within the WLAN. For example, the second device may include a wireless handset. The message transmitted to the second device instructs the second device to gather a second performance metric associated with the second device. The method further includes receiving the second performance metric from the second device and transmitting the first and second performance metric from the first device operating within the WLAN to a network operator over an IP network, wherein the network operator is external to a range of the wireless local area network.

A system for remotely monitoring a performance of a wireless network includes the access point device operating within the wireless network and the user device operating within the wireless network, wherein the user device is operable to communicate with the access point device. The access point device is operable to gather a first performance metric and the user device is operable to gather a second performance metric. The system also includes the network operator, which is located outside of a range of the wireless network and may receive the performance metrics gathered by the access point device and the user device.

A user device operating in a wireless network includes a microphone for receiving audio data from a user, a speaker for presenting audio data to the user, and a processor operable to receiving messages from an access point device instructing the user device to gather performance metrics associated with the wireless network. The user device may also include an interface for transmitting at least one of the gathered performance metrics to a network operator via an access point device, wherein the network operator is located external to a range of the wireless network.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1A illustrates a system for monitoring performance metrics associated with a wireless network, according to an embodiment;

FIG. 1B illustrates a flow of data within a system for monitoring performance metrics, according to an embodiment

FIG. 2 illustrates a block diagram of an access point device, according to an embodiment;

FIG. 3 illustrates a block diagram of a user device, according to an embodiment:

FIG. 4 illustrates a flow chart of a method for monitoring performance metrics associated with a wireless network, according to an embodiment; and

FIG. 5 illustrates a block diagram of a general purpose computing platform, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

According to an embodiment, systems and methods described herein allow for the efficient monitoring of performance metrics associated with a wireless network. Performance metrics refer to measurements and parameters associated with a wireless network. For example, in voice applications, performance metrics may include perceptual evaluation of speech quality (PESQ) standards. Similarly, in video applications, performance metrics may include video quality experts group (VQEG) standards. An example of general performance metrics includes received signal strength indication (RSSI) standards. These standards utilize measurements, such as packet loss, latency, jitter, bandwidth, signal level, noise level, interference level, mean opinion score (MOS), etc. Performance metrics may also include service quality assessments and subjective measurements. For example, a user's satisfaction with a wireless network and/or a user device operating in the wireless network may be evaluated as a performance metric. The phrase “associated with a wireless network” includes all aspects of a wireless network, such as the environment in which the wireless network is operating, the user devices operating in the network, etc. The monitored performance metrics associated with the wireless network may be correlated to baseline or historical standards to dynamically ascertain network performance, as discussed below.

The wireless networks described herein include communication paths, which do not require a physical transmission medium, such as wires, cables, etc. For instance, wireless networks include WLAN, WiMAX, WAN, GSM-WiFi, CDMA-WiFi, WiFi, GSM-WiMAX-WiFi, CDMA-WiMax-WiFi, etc. The wireless networks may be connected to wired networks, such as the Internet. For example, a VoIP application may utilize a wireless network inside a user's premises, but may also be connected to the Internet to transmit and receiver audio data, such as voice data, to and from the user's premises.

The wireless networks described herein may comprise a plurality of access point devices and user devices connected thereto. User devices include any electronic device operable to communicate over a wireless network, such as cellular telephones, cordless telephone handsets, wireless computing and gaming devices, laptops and other personal computing devices, personal digital assistants (PDAs), etc. A user device may also include VoIP handsets. VoIP handsets are portable wireless devices, such as multimode handsets, which run a VoIP application and operate on a VoIP system. VoIP systems utilize a wired network, such as the Internet, to transmit and receive audio data.

Access point devices are devices that connect user devices to a wired network. For example, access point device include all forms of modems, such as cable, digital subscriber line (DSL), fiber, etc. Access point devices act as a junction between a wired network and a wireless network and, thus, may also include multimedia terminal adapters (MTAs). Wireless networks may also include wireless gateways or devices for propagating a wireless signal, such as routers, cellular towers, etc. Wireless gateways may be used to link access point devices and user devices, as is known in the art.

According to an embodiment, performance metrics associated with wireless networks may be gathered by the devices operating in the wireless networks, themselves. For instance, access point devices, wireless gateways, and/or user devices may include software, hardware, or a combination of software and hardware allowing these devices to monitor and gather performance metrics associated with wireless networks. For example, an access point device may have the ability to gather performance metrics related to the wireless environment within a user's premises where the access point device is operating. Alternatively, or in addition thereto, a user device within the wireless network may have the ability to gather performance metrics associated with the wireless network. In this example, the user device may be moved to different physical locations within the wireless network to evaluate performance metrics at the different locations. For instance, signal strength measurements at different locations within a user's home or business may be obtained to construct a coverage map of the user's home or business.

According to an embodiment, the performance metrics gathered by the devices in the wireless network may be transmitted to a network operator. The network operator may comprise an individual, such as a trained technician, and/or a computer system, such as a server having software configured to analyze performance metrics, which receives performance metrics associated with a wireless network. The network operator may evaluate the received performance metrics of the wireless network to determine if the operating conditions of the wireless network are satisfactory, or require modification. For example, a computer system receiving the gathered performance metrics may recognize an error in the wireless network and may automatically correct the error and/or send a transmission notifying the user of the error and/or instructing the user to correct the error. In another example, a trained technician may initiate a service call to the user to discuss the problem with the user. A person having ordinary skill in the art will appreciate that any corrective action or combination of corrective actions may be taken. Similarly, evaluation of performance metrics and implementation of corrective action may occur remotely by a network operator and/or locally within the wireless network, as discussed in greater detail below.

In this manner, the systems and methods according to the embodiments described herein facilitate the monitoring of a wireless network without requiring the dispatch of a skilled technician to a user's premises and without the need for user training and involvement. Moreover, the systems and methods may centralize data collection and reporting of wireless network operations, while enabling devices operating in the wireless networks to be remotely accessed. In addition, the systems and methods do not require all user devices to support the functionality described herein. On the contrary, a specific device may be equipped with the ability to monitor and evaluate other devices in a wireless network. For example, a corporation may include dozens or hundreds of user devices connected to a wireless network. However, this corporation may only need one device equipped with the functionality described herein, to monitor and evaluate the dozens or hundreds of other user devices.

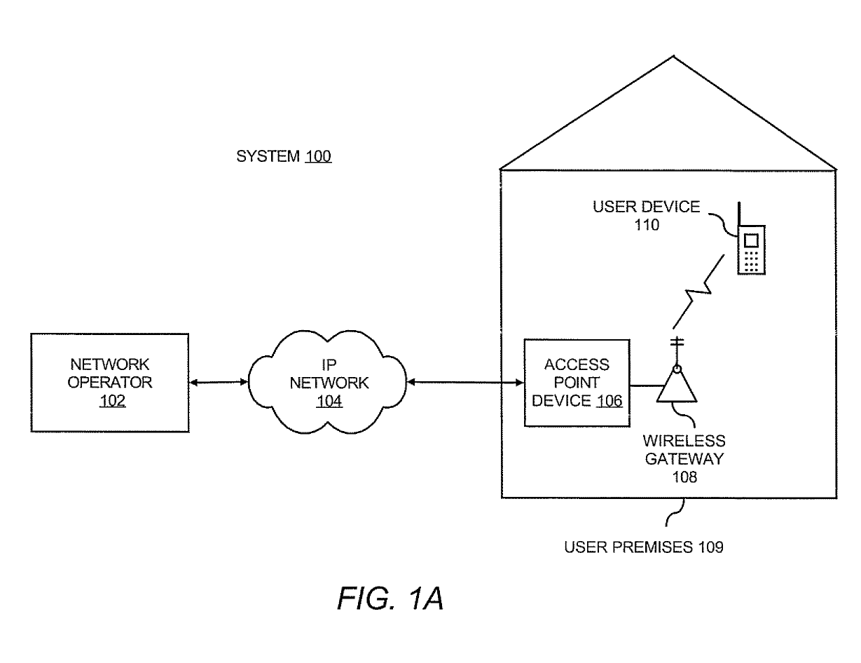

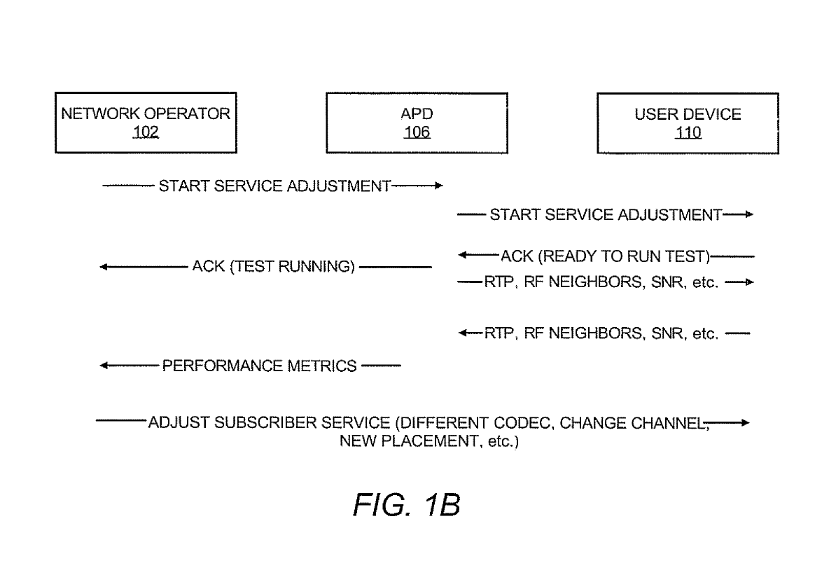

FIG. 1A illustrates a high-level diagram of a system 100 for monitoring performance metrics associated with a wireless network, according to an embodiment. The system 100 includes a network operator 102 connected to an access point device 106 via an internet protocol (IP) network 104. It should be understood that the following description of the system 100 is but one manner of a variety of different manners in which such a system 100 may be configured. In addition, it should be understood that the system 100 may include additional components and that some of the components described herein may be removed and/or modified without departing from a scope of the system 100.

The network operator 102 may be a computer system configured to receive performance metrics over the IP network 104. In a simplest embodiment, the network operator 102 may be a storage device configured to receive and store data, including the performance metrics received over the IP network 104. However, the network operator 102 may also comprise hardware and/or software for evaluating performance metrics and taking corrective action. For example, the network operator 102 may comprise a computer system having software configured to create a coverage map of a user's premises and store this map in a database. As set forth above, the network operator 102 may also include a human technician to evaluate performance metrics and/or speak to the user.

The IP network 104 may be any reasonably suitable IP network, such as the Internet. The user premises 109 includes any region where a wireless network is operating, such as a home, office building, etc. The access point device 106 may be a device for connecting to the IP network 104 to facilitate the transmission of data between the user device 110 and the IP network 104. For example, the access point device 106 may be a modem and/or an MTA, as described above. The user device 110 is depicted in FIG. 1A as a handset for the transmission of audio data, such as voice data. However, the user device 110 may be any device operable to connect to a wireless network, such a cellular telephone, a VoIP handset, a personal computer (PC), music device, such as MP3 players, etc. As such, the user device 110 may transmit any other forms of media, such as music, modem tones and frequencies, text, photographs, videos and other forms of data, etc. While FIG. 1A illustrates only one user device 110, the system 100 may comprise any reasonably suitable number of user devices 110 operating in the wireless network.

The access point device 106 depicted in the system 100 utilizes a wireless gateway 108 for defining the wireless network within a user's premises 109. The wireless gateway 108 is a device for broadcasting a wireless signal to create a wireless network. For example, as set forth above, the wireless gateway 108 may be a wireless router. In another example, the wireless gateway may be a cellular tower. In this particular example, the user device 110 may include cellular telephones interacting with the wireless gateway 108 and, of course, the cellular tower may be located externally to the user premises 109. The wireless gateway 108 may use any reasonably suitable protocol for broadcasting a wireless network, such as real time transport protocol (RTTP). Although the wireless gateway 108 and the access point device 106 are depicted in FIG. 1A as two separate and independent devices, a person having ordinary skill in the art will appreciate that the wireless gateway 108 and the access point device 106 may be a single integrated device.

The user premises 109 may be any area within range of the wireless network broadcasted by the wireless gateway 108. For instance, the user premises may include the home or business, and the curtilage thereof, or a wireless customer or subscriber of wireless services. Although the user premises 109 is depicted as a home in FIG. 1A, a person having ordinary skill in the art will appreciate that the user premises 109 may be any area within a wireless network.

As set forth above, performance metrics gathered by the access point device 106, the wireless gateway 108, and/or the user device 110 may be transmitted over the IP network 104 to the network operator 102. In addition, other data associated with the wireless network may also be transmitted to the network operator 102, such as a record of corrective actions taken by the devices in the wireless network. In this manner, the network operator 102 may centralize all data associated with the wireless network and maintain remote records concerning the wireless network.

As mentioned above, the gathering and evaluation of performance metrics and/or the taking of corrective actions may be initiated and/or implemented locally or remotely. That is, the network operator 102 may remotely query the devices in the wireless network for performance metrics to render a service quality assessment. For example, the network operator 102 may instruct the access point device 106 to evaluate the wireless network associated therewith. As such, the access point device may, in turn, instruct any and all devices commutating over the wireless network to transmit performance metrics to the access point device 106. Thus, the user device 110 may transmit a signal strength measurement, for instance, to the access point device 106.

Alternatively, or in addition thereto, the devices themselves, such as the access point device 106, the wireless gateway 108, and the user device 110, may initiate the monitoring and gathering of performance metrics to self-manage the wireless network. For example, a VoIP handset operating in the user premises 109 may periodically gather and evaluate performance metrics on a predetermined schedule or may gather and evaluate performance metrics when an operating parameter, such as signal strength, falls below a predetermined threshold. In this example, the VoIP handset may take corrective actions without instructions from the network operator 102 and may, for instance, change channels, to improve signal quality. This self-management feature may be alternatively enabled or disabled by a user. In either event, the gathered performance metrics may be transmitted to the network operator 102 for storage and/or further evaluation.

FIG. 1B illustrates a flow of data between the network operator 102, the access point device 106, and the user device 110, shown in FIG. 1A, according to an embodiment. It should be understood that FIG. 1B is merely an illustrative example of how data may flow between the illustrated devices to monitor performance metrics in a wireless network and that data may flow in different orders or in different directions. Similarly, some data flows depicted in FIG. 1B may be unnecessary to monitor performance metrics in a wireless network, just as other data flow not depicted in FIG. 1B may be used to monitor performance metrics in a wireless network.

FIG. 1B illustrates the monitoring of performance metrics initiated by the network operator 102 transmitting a “start service adjustment” signal to the access point device 106. This start service adjustment is an indication that a decision has been made at the network operator 102 to remotely monitor performance metrics of a wireless network that the user device 110 is operating within. This decision may be made manually by a human operator or automatically by a computer system according to a perceived problem or according to a random or predetermined schedule. A person having ordinary skill in the art will appreciate that, in other embodiments, the decision to monitor performance metrics may be initiated by the access point device 106 or the user device 110.

In FIG. 1B, the start service adjustment signal is transmitted by the access point device 106 to the user device 110, so that performance metrics associated with the user device 110 may be gathered by the user device 110. However, in other embodiments, the start service adjustment may not be sent to the user device 110 and performance metrics may be gathered by the access point device 106.

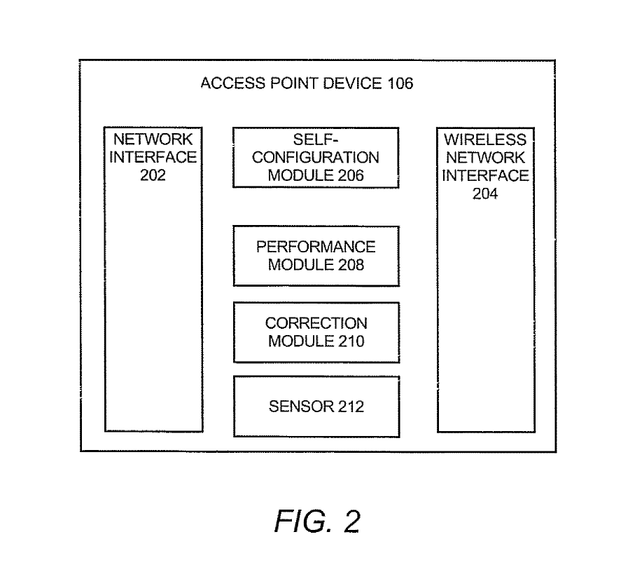

According to the embodiment depicted in FIG. 2, an “Ack (ready to run test)” message, which is an acknowledgement that the user device 110 is prepared to gather performance metrics, is transmitted from the user device 110 to the access point device 106. The access point device 106 may transmit an “Ack (test running)” message to the network operator 102, signifying that performance metrics are being gathered. However, a person having ordinary skill in the art will appreciate that this transmission, like other data flows depicted in FIG. 1B, is optional.

FIG. 1B further depicts an “RTP, RF neighbors, SNR, etc.” message sent from the access point device 106 to the user device 110. This message provides specific instructions concerning the type of performance metrics that the user device 110 is to gather. For example, RF neighbors refers to any other wireless devices utilizing RF signals that are operating within range of the user device 110. RF neighbors may include a variety of devices ranging from garage door openers to laptop computers. SNR refers to signal-to-noise ratio, which is just one of many performance metrics that the user device 110 may gather. The abbreviation RTP refers to real-time transport protocol, which is a protocol used to transport audio packets between a modem and VoIP phone. Thus, the user device 110 may be a VoIP handset and the RTP, RF neighbors, SNR, etc message instructs the VoIP handset as to the type of protocol that should be used to transport the gathered performance metrics.

When the performance metrics have been gathered by the user device 110, the gathered performance metrics may be sent to the access point device 106 in a return RTP, RF neighbors, SNR, etc message. The access point device 106 may then transmit the performance metrics to the network operator 102, which may analyze the performance metrics to determine to evaluate the performance of the wireless network that the user device 110 is operating within. If the network operator 102 determines that the wireless network is not performing optimally, the network operator 102 transmits an “adjust subscriber service” message to the access point device 106 and/or the user device 110. FIG. 1B depicts this message as including three different corrections: “different codec, change channel, new placement, etc.” Different codec refers to an encoded transmission signal used in the wireless network and instructs the user device 110 to change to a different coding mechanism. Change channel instructs the user device 110 to change to a different RF channel, and new placement instructs the user of the user device 110 to place the user device 110 in a different location. Thus, the adjust subscriber service message attempts to correct any problems found with the wireless network. A person having ordinary skill in the art will appreciate that the adjust subscriber service message may only include a single correction message or may include more than three corrections. Similarly, the three corrections shown are only illustrative examples and other corrections not shown in FIG. 1B may also be made.

FIG. 2 illustrates a block diagram of the access point device 106, according to an embodiment. It should be understood that the following description of the access point device 106 is but one manner of a variety of different manners in which such an access point device 106 may be configured. In addition, it should be understood that the access point device 106 may include additional components and that some of the components described herein may be removed and/or modified without departing from a scope of the access point device 106.

The access point device 106 comprises a network interface 202 for connecting to a network, such as the IP network 104, shown in FIG. 1A, and a wireless network interface 204 for connecting to the user device 110, shown in FIG. 1A. The wireless network interface 204 may comprise the wireless gateway 108, shown in FIG. 1A, or may include an interface for connecting to the user device 110 through the wireless gateway, as is known in the art. The access point device 106 also comprises a self-configuration module 206, a performance module 208, and a correction module 210. However, as set forth above, the access point device 106 may include additional modules not illustrated in FIG. 2 or may operate in the system 100 without one or more of the modules depicted in FIG. 2.

The three modules depicted in FIG. 2 may include hardware, software, or a combination of hardware and software. In one example, the modules may be programs operating on the access point device 106. The self-configuration module 206 configures the access point device 106 to gather performance metrics and/or transmit and receive performance metric communications to and from devices connected to the wireless network. The access point device 106 may utilize parameters, such as packet size, transport protocol, port, packet expiry, packet interval, etc to self-configure the access point device 106. Thus, the access point device 106 may invoke the self-configuration module 206 to transition the access point device 106 into a performance metrics mode, in which the access point device 106 may utilize the performance module 208, described below, to gather, receive, and transmit performance metrics.

The performance module 208 gathers performance metrics associated with the wireless network. For example, the performance module 208 may gather data related to RF interference within the operating environment of the access point device 106. The performance module may also gather data concerning the number, types, signal strength, etc. of devices communicating with the access point device 106. The performance module 208 may also query the user device 110 to gather performance metrics associated with the user device 110. A person having ordinary skill in the art will understand that the performance metrics discussed above are but a few illustrative examples of performance metrics that may be gathered by the performance module 208 and that other performance metrics may be gathered without limitation.

The access point device 106 depicted in FIG. 2 includes a sensor 212, which may be any device used by the performance module 208 to gather performance metrics. For example, the sensor 212 may include an antenna on the access point device 106. The sensor 212 may also include other sensing equipment, such as temperature sensors, etc. The sensor 212 may be an integral component of the performance module 208, or the sensor 212 may be a separate and independent component, as depicted in FIG. 2.

Once gathered, the performance module 208 evaluates the performance metrics, which may be correlated against initial installation performance metrics, optimal performance metrics, historical performance metrics, threshold performance metrics, etc. For instance, the performance module 208 may determine that a substantial amount of interference is obstructing signal quality in the wireless network, or that an excessive number of user devices 110 are attempting to communicate with the access point device 106. In another example, the performance module 208 may render a quality of service assessment for the wireless network or a particular user device 110 connected to the wireless network. Alternatively, or in addition thereto, the performance module 208 may transmit gathered and/or evaluated performance metrics to the network operator 102 for evaluation and/or storage.

The correction module 210 takes corrective action to improve communication in the wireless network. The correction module 210 may be invoked based on an evaluation performed by one or more of the access point device 106 and the network operator 102. For example, the performance module 208 may determine that a problem exists with the wireless network. Therefore, the correction module 210 may perform a number of actions in an attempt to ameliorate the detected problem in the wireless network. Corrective actions may include, but are not limited to, notifying a user of the problem, recommending a change in service to the user, implementing a change in service to the user, dynamically altering existing parameters of the wireless network, such as changing the users operating channel dynamically due to a source of interference, etc. For instance, a change in service may include upgrading a users Internet service to a premium package or providing additional services to a user at an increased cost. One or more of the corrective actions described above may be sent to an access point device 106 and/or a user device 110 in an adjust subscriber service message, as described in FIG. 1B. A person having ordinary skill in the art will understand that the corrective actions discussed above are but a few illustrative examples of corrective actions that may be performed by invoking the correction module 210 and that other corrective actions may be performed without limitation. The access point device 106 may transmit a record of the corrective actions taken by invoking the correction module 210 to the network operator 102.

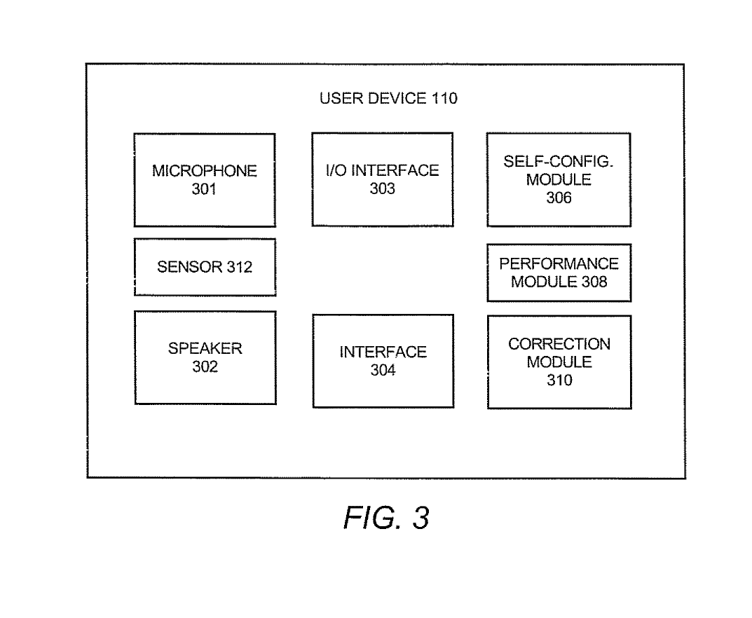

FIG. 3 illustrates a block diagram of the user device 110, according to an embodiment. It should be understood that the following description of the user device 110 is but one manner of a variety of different manners in which such a user device 110 may be configured. In addition, it should be understood that the user device 110 may include additional components and that some of the components described herein may be removed and/or modified without departing from a scope of the user device 110.

The user device 110 depicted in FIG. 3 may be a handset for transmitting and receiving voice data. For example, the user device 110 may be a handset for a VoIP system. However, a person having ordinary skill in the art will appreciate that, in other examples, the user device 110 may be any other device operable to communicate over a wireless network, such as a PC or a wireless gaming device, to transmit and receive other forms of media.

As a handset, the user device 110 comprises a microphone 301 for receiving voice data and a speaker 302 for presenting voice data, as is known in the art. The user device 110 also comprises an I/O interface, which may be one or more of a plurality of devices, such as a keyboard, a number pad, a display, etc. to allow a user to interact with the user device 110. The user device 110 also comprises a wireless network interface 304, which may allow the user device 110 to interact with the wireless gateway, 108 and/or the access point device 106. In one example, the interface 304 allows the user device 110 to communicate directly with the network operator 102 without connecting to the IP network 104. For instance, in this example, the user device 110 may be a cellular telephone and the user may place a voice call directly to the network operator 102.

The user device 110 includes a self-configuration module 306, a performance module 308, and a correction module 310, which may have similar functionality to the modules described above with respect to FIG. 2. However, a person having ordinary skill in the art will appreciate that the need for these modules within the user device 110 may be obviated by there inclusion into the access point device 106. Alternatively, one or more of the modules depicted in FIG. 3 may be present in the user device 110 in addition to having one or more of the modules depicted in FIG. 2 present in the access point device 106.

The self-configuration module 306 configures the user device 110 to gather performance metrics and/or transmit and receive performance metric communications to and from devices connected to the wireless network. The user device 110 may utilize parameters, such as packet size, transport protocol, port, packet expiry, packet interval, etc, which are complimentary to the parameters used by the access point device 106 to self-configure the access point device 106. Thus, the user device 110 may invoke the self-configuration module 306 to transition the user device 110 into a performance metrics mode, which allows the user device 110 to utilize the performance module 308, described below, to gather and transmit performance metrics.

The performance module 308 gathers and/or evaluate performance metrics, substantially as described above with respect to the performance module 206. For instance, in one example, the user device 110 may be moved to different physical locations within the wireless network. The user device 110 may invoke the performance module 308 to gather performance metrics, such as signal strength, at each of the different locations.

The user device 110 depicted in FIG. 3 includes a sensor 312, which may be any device used by the performance module 308 to gather performance metrics. For example, the sensor 312 may include an antenna. The sensor 312 may also include other sensing equipment, such as temperature sensors, etc., for physically acquiring the performance metrics.

These performance metrics may be used to generate a coverage map of the user premises 109, which may be stored locally at the user device 110 or the access point device 106. A coverage map refers to a mapping of the wireless network showing areas of relative signal strength and connectivity within the wireless network. For example, a coverage map may indicate that the user device 110 has a strong signal strength in one region of the wireless network, but poor signal strength in another region of the wireless network. The user device 110 may also include a location unit (not shown), such as a GPS device for transmitting the location of the user device 110 to the access point device 106. Alternatively, or in addition thereto, the location unit may be a device, which provides the position of the user device 110 in relation to a known landmark, such as the access point device 106. In another example, a user may manually enter the location into the user device 110 or the access point device 106 to assist in the generation of a coverage map. The coverage map may be used to identify problems in a wireless network and allow a user to avoid areas of poor signal strength. Alternatively, or in addition thereto, the gathered performance metrics and/or the generated coverage map may be transmitted to the network operator 102 for storage and/or further evaluation.

Similarly, the correction module 310 may be invoked by the user device 110 to take corrective actions to ameliorate any problems discovered in the wireless network, as described above. For example, the user device 110 may invoke the correction module 310 to change the RF channel that the user device 110 is operating on.

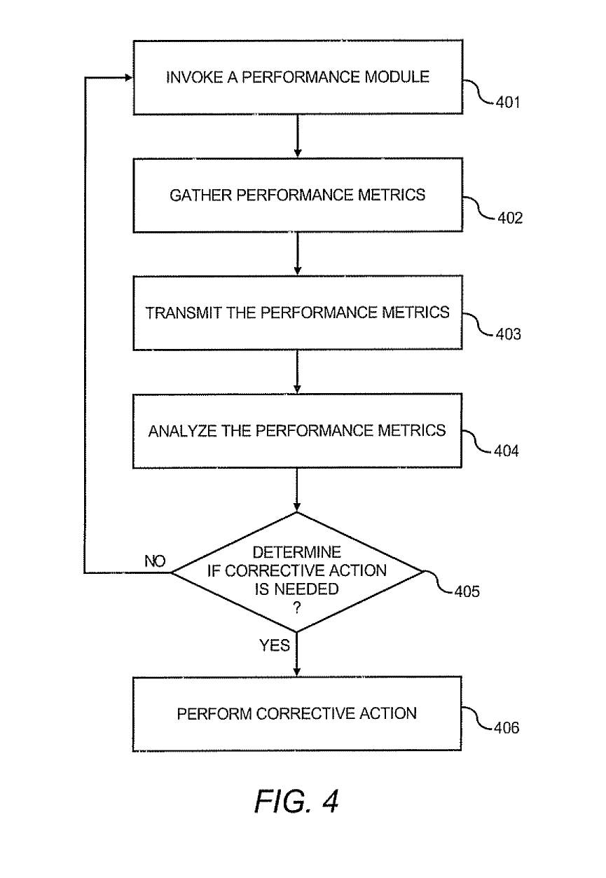

FIG. 4 depicts a flow chart of an illustrative method 400 for remotely monitoring performance metrics associated with a wireless network. The method 400 is described with respect to FIGS. 1, 2, and 3 by way of example and not limitation and it will be apparent that the method 400 may be used in other systems. Moreover, it will also be apparent to a person having ordinary skill in the art that certain steps in the method 400 are optional and, similarly, that additional steps may be inherent or added to the method 400.

The method 400 is for monitoring performance metrics associated with a wireless network “remotely” in the sense that performance metrics may be gathered locally from a device operating within the wireless network and these gathered performance metrics may be transmitted to another device external to the wireless network. For example, the access point device 106 and/or the user device 110 may gather performance metrics associated with the wireless network that the access point device 106 and/or the user device 110 are operating within. These gathered performance metrics may then be transmitted out of the wireless network to a network operator 102.

At step 401, a performance module, such as the performance module 208, is invoked on a device operating within the wireless network to gather performance metrics. As set forth above, the performance module may include a software program, which executes on a processor by the device operating within the wireless network to gather performance metrics associated with the wireless network. The device operating within the wireless network may include a user device 110, such as a VoIP handset, and/or an access point device 106, such as a modem. The performance module may be invoked remotely by the network operator 102 or locally by the device operating within the wireless network. For example, the access point device 106 may invoke the performance module locally, without a request from the network operator 102 to self-manage the wireless network and independently report problems with the wireless network to the network operator 102. This self-management feature may be alternatively enabled or disabled by a user. When enabled, the timing with which the devices gather performance metrics may be adjusted by the user.

At step 402, performance metrics are gathered by the device operating within the wireless network. For example, the access point device 106 and/or the user device 110 may utilize the performance module 208 and/or 308, respectively, to gather performance metrics associated with the wireless network in which the access point device 106 and/or the user device 110 are operating. Performance metrics “associated with” the wireless network include measurements and parameters related to the environment in which the wireless network is operating and the devices within the wireless network. For instance, performance metrics may include the signal strength that the user device 110 has with the access point device 106 or the wireless gateway 108. Performance metrics may also include an amount of interference from other device operating within range of the wireless network. The performance metrics may be gathered by utilizing a sensor 212, 312.

At step 403, the performance metrics are transmitted from the wireless device to a network operator 102. The performance metrics may be transmitted over a wired network, such as the Internet. The network operator 102 may include a server and/or a human technician. The network operator 102 may store the performance metrics and may evaluate the performance metrics to analyze the performance of the wireless network.

At step 404, the performance metrics may be analyzed. For example, the network operator 102 may process and compare the gathered performance metrics to PESQ standards, VQEG, and/or RSSI standards. These standards utilize measurements, such as packet loss, latency, jitter, bandwidth, signal level, noise level, interference level, mean opinion score (MOS), etc. Alternatively, or in addition thereto, the gathered performance metrics may be compared to historical metrics associated with the wireless network or with similar wireless networks.

At step 405, a determination may be made if correction actions is needed. For instance, if the gathered performance metrics do not meet historical expectations, then corrective action may improve the wireless network. If no corrective action is taken, the method 400 returns to step 401. However, if it is determined that corrective action should be taken, the method 400 continues to step 406.

At step 406, corrective action may be taken to improve the performance of the wireless network. For example, the channel that the user device 110 is operating on may be changed. Corrective action may be taken by invoking the correction modules 210 and/or 310 and may be initiated and implemented remotely by the network operator 102 or locally within the wireless network by a device operating within the wireless network.

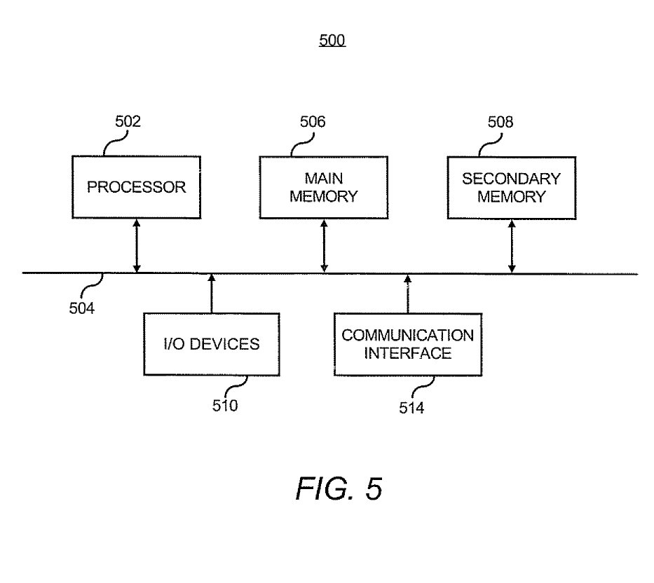

FIG. 5 illustrates a block diagram of a general purpose system 500 that is operable to be used as a platform for the components of the system 100 described above. The general purpose system 500 may be used as, or may comprise a part of the network operator 102, the access point device 106, the wireless gateway 108, or the user device 110. Furthermore, components may be added to or removed from the general purpose system 500 to provide the desired functionality.

The system 500 includes a processor 502, providing an execution platform for executing software, such as the self-configuration modules 206 and 306, the performance modules 208 and 308, and the correction modules 210 and 310. For example, the access point device 106 may comprise a processor 502 for the performance module 208 in order to gather performance metrics associated with a wireless network that the access point device 106 is operating in. Commands and data from the processor 502 are communicated over a communication bus 504. The system 500 also includes a main memory 506, such as a Random Access Memory (RAM), where software may reside during runtime, and a secondary memory 508. The secondary memory 508 may include, for example, a nonvolatile memory where a copy of software is stored. In one example, the secondary memory 508 also includes ROM (read only memory), EPROM (erasable, programmable ROM), EEPROM (electrically erasable, programmable ROM). However, the secondary memory 508 is optional and may not be included in systems and methods described herein.

The system 500 includes I/O devices 510. The I/O devices may include a display and/or user interfaces comprising one or more I/O devices 510, such as a keyboard, a mouse, a stylus, and the like. For example, the I/O devices 510 may include a number pad and/or a keyboard on the user device 110 for entering telephone numbers. A communication interface 514 is provided for communicating with other components. For example, the communication interface 514 may include RF transmitters and receivers on the user device 110 for sending and receiving RF signals. The communications interface 514 may facilitate connection to a network, such as the wireless network described above or the IP network 104.

One or more of the steps described herein are operable to be implemented as software stored on a computer readable medium, such as the memory 506 and/or 508, and executed on the system 500, for example, by the processor 502.

The steps are operable to be embodied by a computer program, which can exist in a variety of forms both active and inactive. For example, they exist as software program(s) comprised of program instructions in source code, object code, executable code or other formats for performing some of the steps. The codes described above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. An access point device operating within a wireless local area network comprising:
a network interface operable to facilitate communication with a network operator over an IP network, wherein the network operator is located outside of a range of the wireless local area network;
a wireless network interface operable to facilitate communication between the access point device and a user device operating within the wireless local area network; and
a processor operable to
gather a first performance metric associated with the access point device,
instruct the user device to gather a second performance metric associated with the user device,
receive the second performance metric gathered by the user device in response to the instructions from the access point device to gather the second performance metric, and
transmit the first and second performance metrics over the IP network to the network operator.

2. The access point device of claim 1, wherein the access point device is operable to receive a message via the network interface instructing the access point device to gather the first and second performance metrics.

3. The access point device of claim 2, wherein the user device is a handset for transmitting and receiving audio data and the second performance metric received from the user device is signal strength.

4. The access point device of claim 1, wherein the processor invokes a performance module to gather the performance metrics.

5. The access point device of claim 1, wherein the access point device is operable to initiate the gathering of the first and second performance metric.

6. The access point device of claim 1, wherein the processor is further operable to invoke a correction module to modify a condition of the wireless local area network.

7. The access point device of claim 1, wherein the access point device comprises a modem.

8. A method for remotely monitoring performance of a wireless local area network comprising:
invoking a performance module on a first device operating within the wireless local area network;
gathering a first performance metric associated with the wireless local area network locally by the first device;
transmitting a message to a second device operating within the wireless local area network, wherein the message instructs the second device to gather a second performance metric associated with the second device;
receiving the second performance metric from the second device; and
transmitting the first and second performance metric from the first device operating within the wireless local area network to a network operator over an IP network, wherein the network operator is located outside of a range of the wireless local area network.

9. The method of claim 8, wherein invoking a performance module comprises:
receiving a signal from the network operator instructing the first device to invoke the performance module.

10. The method of claim 8, wherein receiving the second performance metric comprises:
receiving the second performance metric by an access point device from a handset operating within the wireless local area network.

11. The method of claim 10, wherein the receiving the second performance metric by the access point device from the handset operating within the wireless local area network further comprises:
receiving the second performance metric multiple times from the handset when the handset is located in different physical locations within the wireless local area network.

12. The method of claim 11, further comprising:
generating a coverage map of the wireless local area network in response to receiving the second performance metric multiple times.

13. The method of claim 8, further comprising:
analyzing the gathered first and second performance metric to evaluate the performance of the wireless local area network.

14. The method of claim 8, further comprising:
transitioning the first device from a normal operating mode into a performance metrics mode to gather performance metrics.

15. The method of claim 8, further comprising:
modifying an operating condition of a the second device within the wireless local area network to improve performance of the wireless local area network.

16. A system for remotely monitoring a performance of a wireless network comprising:
an access point device operating within the wireless network, wherein the access point device is operable to gather a first performance metric associated with the access point device; and
a user device operating within the wireless network, wherein the user device is operable to communicate with the access point device and gather a second performance metric associated with the user device, and
wherein the access point device and the user device are configured to transmit the first and second performance metric to a network operator, which is located outside of a range of the wireless network.

17. The system of claim 16, wherein the network operator includes a server operable to query the access point device to receive the first and second performance metric and analyze the received first and second performance metric to evaluate a performance of the wireless network.

18. The system of claim 16, wherein network operator is operable to remotely implement modifications to the wireless network.

19. A user device operating in a wireless network comprising:
a microphone for receiving audio data from a user;
a speaker for presenting audio data to the user; and
a processor operable to
receiving messages from an access point device instructing the user device to gather performance metrics associated with the wireless network; and
an interface for transmitting at least one of the gathered performance metrics to a network operator via an access point device, wherein the network operator is located externally of the wireless network.

20. The user device of claim 19, wherein the processor is operable to receive signals from the access point device instructing the user device to gather the performance metric and transmit the gathered performance metrics to the access point device.
